(19) United States
(12) Patent Application Publication
(10) Pub. No.: US 2018/0335656 A1
(43) Pub. Date: Nov. 22, 2018

(54) ULTRA-THIN LIQUID CRYSTAL DISPLAY DEVICE AND METHOD FOR MANUFACTURING THE SAME

(71) Applicant: Shenzhen China Star Optoelectronics Technology Co., Ltd., Shenzhen, Guangdong (CN)

(72) Inventors: Zhenxia Chen, Shenzhen, Guangdong (CN); Lixuan Chen, Shenzhen, Guangdong (CN)

(73) Assignee: Shenzhen China Star Optoelectronics Technology Co., Ltd., Shenzhen, Guangdong (CN)

(21) Appl. No.: 15/326,236

(22) PCT Filed: Dec. 23, 2016
(86) PCT No.: PCT/CN2016/111772

§ 371 Date: Jan. 13, 2017

(30) Foreign Application Priority Data
Aug. 30, 2016 (CN) 201610764679.0

(51) Int. Cl. G02F 1/1334; F21V 8/00

(52) U.S. Cl. CPC G02F 1/1334; G02B 6/0036; G02B 6/0065; G02B 6/0061

(57) ABSTRACT

Disclosed are an ultra-thin liquid crystal display device and a method for manufacturing the same. According to the method, polymer dispersed liquid crystals serve as a liquid crystal layer, and bright and dark display can be realized without polaroid being provided therein. One substrate in the display device is manufactured as a light guide plate to replace a traditional independent backlight module, so that a thickness of the ultra-thin liquid crystal display device is in a range from 1.02 mm to 3.3 mm. A high light transmittance rate and thinning of the display device can be realized.

### CROSS-REFERENCE TO RELATED APPLICATIONS

The present application claims the priority of Chinese patent application CN201610764679.0, entitled “Ultra-thin liquid crystal display device and method for manufacturing the same” and filed on Aug. 30, 2016, the entirety of which is incorporated herein by reference.

### FIELD OF THE INVENTION

The present disclosure relates to the technical field of liquid crystal display device, and in particular, to an ultra-thin liquid crystal display device and a method for manufacturing the same.

### BACKGROUND OF THE INVENTION

A liquid crystal display (LCD) device comprises a frame, a liquid crystal display panel and a backlight module. The liquid crystal display panel comprises a color filter (CF) substrate, a thin film transistor array substrate (TFT array substrate) and liquid crystal (LC) filled between the two substrates. Transparent electrodes are arranged on an inner side of the CF substrate and an inner side of the TFT array substrate which face each other. The orientation of liquid crystal molecules of the liquid crystal display device is controlled through an electric field to change a polarization state of light. A polarizer is arranged, and thus a polarized light can transmit therethrough or be blocked. In this manner, a display function of the display device can be realized. For example, a traditional liquid crystal display device (as shown in FIG. 1) comprises a liquid crystal display panel and a backlight module 1. The liquid crystal display panel mainly comprises an upper substrate 5 (with a thickness of 0.5-0.7 mm), a lower substrate 3 (with a thickness of 0.5-0.7 mm), an upper polaroid 6 (with a thickness of 0.2 mm) attached to an upper surface of the upper substrate 5, a lower polaroid 2 (with a thickness of 0.2 mm) attached to a lower surface of the lower substrate 3, and a liquid crystal layer 4 filled between the upper substrate 5 and the lower substrate 3 (a thickness of the liquid crystal layer 4 is very small and can be ignored in overall thickness). Such structure makes the whole liquid crystal display device very thick, and a thickness thereof can reach 11.4-21.8 mm.

At present, the liquid crystal display device serves as a display screen of an electronic device and has already widely applied to various electronic products. High-brightness, low-power-consumption and thin electronic devices are increasingly pursued in the market. For example, existing notebook computers, mobile phones, tablet personal computers and other electronic devices comprising the liquid crystal display device are manufactured to be more and more thin and bright, and meanwhile low power consumption is also required. Therefore, the liquid crystal display devices also need to be produced thinner and thinner, and a high light transmittance rate is required so as to realize high brightness under low power consumption. On the aspect of light transmittance rate, since the liquid crystal display panel does not emit light itself, the backlight module is needed to serve as a light source. Since the light transmittance rate of the LCD is rather low, most of the backlight is wasted and the light utilization rate of the LCD is very low. The low light transmittance rate of the LCD is caused by multiple factors, including polaroids, CF, electrodes and so on, which have shielding and absorbing effects on light. Especially the polaroids and the CF, their light transmittance rate are 42% and 30% respectively and are the main factors of the low light transmittance rate of the LCD. On the thinning aspect, a thickness of the backlight module accounts for more than one half of the total thickness of the whole liquid crystal display device. Therefore, whether the liquid crystal display device can be thinned or not directly depends on the backlight module. Therefore, a method is needed to produce a thin backlight module so as to obtain a thin liquid crystal display device.

### SUMMARY OF THE INVENTION

The present disclosure aims at solving the technical problem that a liquid crystal display (LCD) device in the prior art has a low light transmittance rate and a large thickness.

In order to solve the technical problem, the present disclosure provides an ultra-thin liquid crystal display device and a method for manufacturing the same. In the method for manufacturing the ultra-thin liquid crystal display device provided herein, no polaroid is provided, while a polymer dispersed liquid crystal (PDLC) structure is used for improving a light transmittance rate. Meanwhile, one substrate in a liquid crystal display device is manufactured as a light guide plate to realize a backlight function replacing a traditional independent backlight module, and thus ultra-thinning of the liquid crystal display device can be achieved. A thickness of the ultra-thin liquid crystal display device manufactured by the method of the present disclosure is in a range from 1.02 mm to 3.3 mm and is remarkably reduced compared with a traditional liquid crystal display device.

According to a first aspect of the present disclosure, an ultra-thin liquid crystal display device is provided. The ultra-thin liquid crystal display device comprises a liquid crystal cell, which comprises a first substrate, a second substrate arranged facing the first substrate, and a liquid crystal layer arranged between the first substrate and the second substrate. The liquid crystal layer has a polymer dispersed liquid crystal structure, which comprises a polymer layer and liquid crystal droplets dispersed in the polymer layer.

The first substrate or the second substrate of the liquid crystal cell is provided with lattice points on a back side thereof. The ultra-thin liquid crystal display device further comprises an LED light bar arranged on a lateral surface of the first substrate or the second substrate which contains the lattice points.

Preferably, the liquid crystal droplets have an elliptical ball shape.

Preferably, a size of the liquid crystal droplets is in a range from 10 nm to 1000 nm.

Further preferably, the liquid crystal layer is prepared by a mixture of a polymerizable monomer and liquid crystal molecules after polymerization reaction by treatment of Ultra Violet (UV) irradiation, heating or cation curing.

Further preferably, a content of the polymerizable monomer is 10%-60% by weight of the mixture.

Further preferably, the polymerizable monomer includes one or more selected from a group consisting of acrylic acid, acrylate and derivatives thereof, methacrylate and derivatives thereof, styrene and derivatives thereof, epoxy resin and a fatty amine epoxy curing agent.

Further preferably, the first substrate or the second substrate which contains the lattice points is made of a non-glass material.

Further preferably, a thickness of the ultra-thin liquid crystal display device is in a range from 1.02 mm to 3.3 mm.

According to a second aspect of the present disclosure, a method for manufacturing an ultra-thin liquid crystal display device is provided. The method includes steps of:

S1, providing a first substrate and a second substrate which faces the first substrate, and manufacturing black matrix electrodes on the first substrate and the second substrate:

S2, arranging the mixture of a polymerizable monomer and liquid crystal molecules between the first substrate and the second substrate, wherein a content of the polymerizable monomer is 10%-60% by weight of the mixture:

S3, performing UV irradiation, heating or cation curing on the mixture, so that the polymerizable monomer experiences polymerization reaction to form a polymer layer and liquid crystal droplets dispersed in the polymer layer, wherein the polymer layer and the liquid crystal droplets dispersed in the polymer layer form a liquid crystal layer, and the liquid crystal layer, the first substrate, and the second substrate form a liquid crystal cell; and

S4, forming lattice points on a back side of the first substrate or a back side of the second substrate, and forming an LED light bar on a lateral surface of the first substrate or the second substrate which contains the lattice points to obtain the ultra-thin liquid crystal display device.

Preferably, in step S2, the polymerizable monomer includes one or more selected from a group consisting of acrylic acid, acrylate and derivatives thereof, methacrylate and derivatives thereof, styrene and derivatives thereof, epoxy resin and a fatty amine epoxy curing agent.

Preferably, in step S3, the UV irradiation is performed at a temperature in a range from −30° C. to 120° C., and a baking oven, ultrasound or infrared is used in a heating procedure.

Preferably, the liquid crystal droplets have an elliptical ball shape.

Further preferably, a size of the liquid crystal droplets is in a range from 10 nm to 1000 nm.

Further preferably, in step S4, the first substrate or the second substrate which contains the lattice points is made of a non-glass material.

Further preferably, a thickness of the ultra-thin liquid crystal display device is in a range from 1.02 mm to 3.3 mm.

Compared with the prior art, one embodiment or a plurality of embodiments in the aforesaid technical solutions can have the following advantages or beneficial effects.

In the ultra-thin liquid crystal display device provided by the present disclosure, the polymer dispersed liquid crystals serve as the liquid crystal layer, and bright and dark display can be realized without polaroid being provided therein. One substrate in the display device is manufactured as the light guide plate to replace the traditional independent backlight module, so that the thickness of the ultra-thin liquid crystal display device is in a range from 1.02 mm to 3.3 mm. The thickness is reduced by 10 mm to 20 mm compared with the traditional liquid crystal display device. The method for manufacturing the ultra-thin liquid crystal display device provided by the present disclosure is simple. Not only thinning of the liquid crystal display device can be realized, but also the light transmittance rate thereof is high.

Other features and advantages of the present disclosure will be further explained in the following description, and partly become self-evident therefrom, or be understood through implementation of the present disclosure. The objectives and advantages of the present disclosure will be achieved through the structure specifically pointed out in the description, claims, and the accompanying drawings.

### BRIEF DESCRIPTION OF THE DRAWINGS

The drawings are provided for further understanding of the present disclosure, and constitute one part of the description. They serve to explain the present disclosure in conjunction with the embodiments of the present disclosure, rather than to limit the present disclosure. In the drawings:

FIG. 1 schematically shows a structure of a traditional liquid crystal display device;

FIG. 2 schematically shows a structure of an ultra-thin liquid crystal display device of the present disclosure in an on-state;

FIG. 3 schematically shows a structure of the ultra-thin liquid crystal display device of the present disclosure in an off-state;

FIG. 4 is a top view of a substrate 11 containing lattice points 13 in the ultra-thin liquid crystal display device of the present disclosure;

FIG. 5 is a side view of the substrate 11 containing lattice points 13 in the ultra-thin liquid crystal display device of the present disclosure; and

FIG. 6 is a flow chart of a method for manufacturing the ultra-thin liquid crystal display device of the present disclosure.

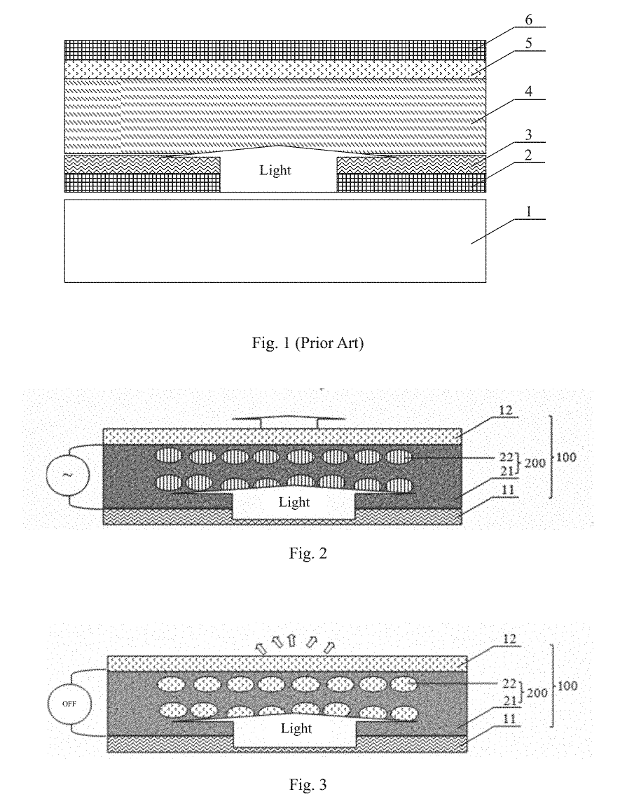

### DETAILED DESCRIPTION OF THE EMBODIMENTS

The implementation way of the present disclosure will be described in detail below in combination with accompanying drawings and embodiments, on the basis, the implementation process about how to apply technical means of the present disclosure for solving the technical problems and achieving the technical effects can be fully understood and implemented. It should be noted that as long as no conflict is produced, the embodiments and all the features of the embodiments in the present disclosure can be mutually combined, and the formed technical scheme falls in the claimed range of the present disclosure.

The present disclosure aims at solving the technical problem that a liquid crystal display (LCD) device in the prior art has a low light transmittance rate and a large thickness. In order to solve the technical problem, the embodiment of the present disclosure provides an ultra-thin liquid crystal display device.

According to the present embodiment, the ultra-thin liquid crystal display device comprises a liquid crystal cell 100, and a structure thereof is shown in FIG. 2 and FIG. 3. The liquid crystal cell 100 comprises a first substrate 11, a second substrate 12 arranged facing the first substrate 11, and a liquid crystal layer 200 arranged between the first substrate 11 and the second substrate 12. The liquid crystal layer 200 has a polymer dispersed liquid crystal structure, which includes a polymer layer 21 and liquid crystal droplets 22 dispersed in the polymer layer 21.

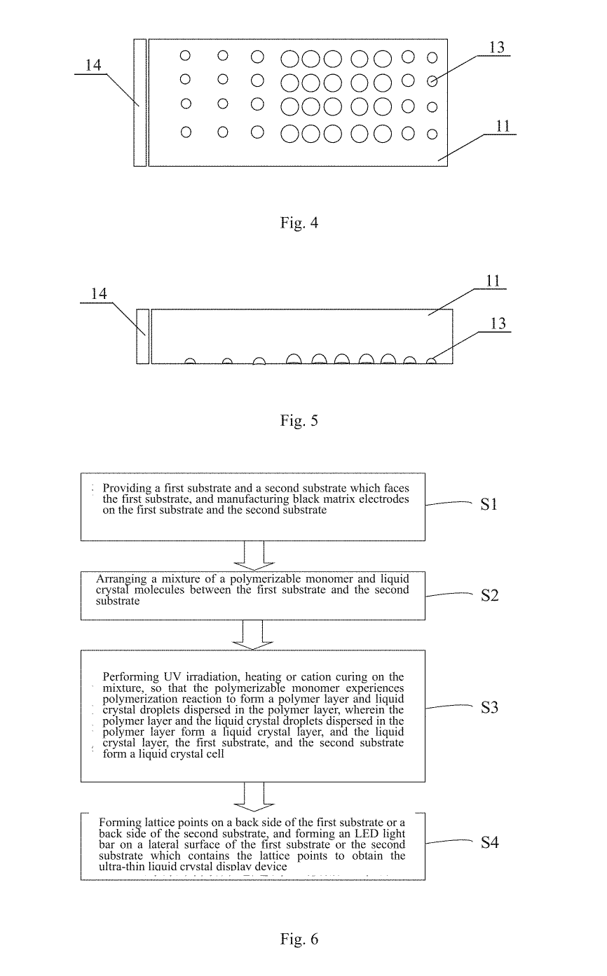

As shown in FIG. 4 and FIG. 5, lattice points 13 are arranged on a back side (i.e., a lower surface) of the first substrate 11. The ultra-thin liquid crystal display device further comprises an LED light bar 14 arranged on a lateral surface of the substrate 11 (i.e., the first substrate) which contains the lattice points 13.

It should be noted that, according to the present disclosure, the substrate 11 which contains the lattice points 13 is used as a light guide plate. The lattice points 13 arranged on the substrate 11 are used for guiding light emitted by the LED light bar 14 arranged on the lateral surface thereof. That is, the lattice points 13 can guide light to the substrate 11 from the lateral surface, and then guide light to the liquid crystal cell 100 uniformly so as to realize a backlight function. The lattice points 13 can be manufactured through a method similar to that of a common light guide plate, which includes laser, etching, injection molding, printing and other technologies. As shown in FIG. 4 and FIG. 5, the lattice points 13 are similar to a common light guide plate in design, and different lattice point densities and sizes are arranged according to different distances thereof from the LED light bar so as to uniformly distribute light in the substrate 11 which contains the lattice points 13 and uniformly guide the light to the liquid crystal cell 100.

In one preferable embodiment of the present disclosure, the liquid crystal droplets 22 have an elliptical ball shape.

In one preferable embodiment of the present disclosure, a size of the liquid crystal droplets 22 is in a range from 10 nm to 1000 nm.

In one preferable embodiment of the present disclosure, the liquid crystal layer 200 is prepared by a mixture of a polymerizable monomer and liquid crystal molecules after polymerization reaction by treatment of UV irradiation, heating or cation curing. A substance in a solid state with a high molecular weight and a high degree of transparency can be obtained after polymerization reaction.

In one preferable embodiment of the present disclosure, a content of the polymerizable monomer is 10%-60% by weight of the mixture.

The polymerizable monomer can be but is not limited to one or a combination selected from a group consisting of acrylic acid, acrylate and derivatives thereof, methacrylate and derivatives thereof, styrene and derivatives thereof, epoxy resin and a fatty amine epoxy curing agent.

When UV light is used to irradiate the mixture of the polymerizable monomer and the liquid crystal molecules, a photoinitiator can be introduced for accelerating UV photopolymerization efficiency. A content of the photoinitiator is 0.01%-3% by weight of the mixture. The photoinitiator can be but is not limited to one or a combination selected from a group consisting of benzil dimethyl ketal, benzophenone and sulfoanthrone.

The substrate 11 which contains the lattice points 13 is made of a non-glass material.

In one preferable embodiment of the present disclosure, the substrate 11 (i.e., the first substrate) which contains the lattice points 13 can be but is not limited to a polyimide (PI) substrate, a polyethylene glycol terephthalate (PET) substrate or a polymethyl methacrylate (PMMA) substrate.

A thickness of the first substrate 11 is in a range from 0.5 mm to 1.5 mm, a thickness of the second substrate 12 is in a range from 0.5 mm to 1.5 mm, and a thickness of the liquid crystal layer 200 is in a range from 0.02 mm to 0.1 mm. Therefore, a thickness of the ultra-thin liquid crystal display device provided herein is in a range from 1.02 mm to 3.3 mm.

As shown in FIG. 2, when the ultra-thin liquid crystal display device is in an on-state (i.e., a voltage is exerted on the liquid crystal cell 100), liquid crystals in the liquid crystal droplets 22 are aligned along an electric field direction under an effect of the electric field. At this time, most of incident light still transmits in an original direction, and the panel is in a bright state. As shown in FIG. 3, when the ultra-thin liquid crystal display device is in an off-state (i.e., the voltage exerted on the liquid crystal cell 100 is zero), liquid crystals in the liquid crystal droplets 22 are arrange randomly, and original collimated incident light is changed to be in a scattered diffuse reflection state under effects such as refraction, reflection and scattering of the liquid crystal droplets 22, a polymer layer 21 interface, the liquid crystal molecules dispersedly distributed in the liquid crystal droplets 22 and so on. At this time, the panel is in a dark state. In this manner, display of different bright and dark states can be realized without a polaroid.

Accordingly, the embodiment of the present disclosure further provides a method for manufacturing an ultra-thin liquid crystal display device. As shown in FIG. 6, the method mainly includes steps S1 to S4.

In step S1, a first substrate 11 and a second substrate 12 which faces the first substrate 11 are provided, and black matrix electrodes (not shown in accompanying drawings) are manufactured on the first substrate 11 and the second substrate 12.

In step S2, a mixture of a polymerizable monomer and liquid crystal molecules is arranged between the first substrate 11 and the second substrate 12. A content of the polymerizable monomer is 10%-60% by weight of the mixture.

The polymerizable monomer can experience a polymerization reaction to form a substance in a solid state with a high molecular weight and a high degree of transparency. The polymerizable monomer can be but is not limited to one or a combination selected from a group consisting of acrylic acid, acrylate and derivatives thereof, methacrylate and derivatives thereof, styrene and derivatives thereof, epoxy resin and a fatty amine epoxy curing agent.

In step S3, UV irradiation (which is conducted at a temperature in a range from −30° C. to 120° C.), heating (a baking oven, ultrasound or infrared is used in a heating procedure) or cation curing is performed on the mixture, so that the polymerizable monomer experiences polymerization reaction to form the polymer layer 21 and the liquid crystal droplets 22 dispersed in the polymer layer 21. The polymer layer 21 and the liquid crystal droplets 22 dispersed in the polymer layer 21 form a liquid crystal layer 200. The liquid crystal layer 200, the first substrate 11, and the second substrate 12 form the liquid crystal cell 100. The liquid crystal droplets 22 have an elliptical ball shape. The size of the liquid crystal droplets 22 is in a range from 10 nm to 1000 nm.

When UV light is used to irradiate the mixture, a photoinitiator can be introduced for accelerating UV photopolymerization efficiency. A content of the photoinitiator is 0.01%-3% by weight of the mixture. The photoinitiator can be but is not limited to one or a combination selected from a group consisting of benzil dimethyl ketal, benzophenone and sulfoanthrone.

In step S4, lattice points 13 are formed on a back side (i.e., a lower surface) of the first substrate 11, and then an LED light bar 14 is formed on a lateral surface of the substrate 11 (i.e., the first substrate) which contains the lattice points 13 to obtain the ultra-thin liquid crystal display device.

The substrate 11 which contains the lattice points 13 is made of a non-glass material.

In one preferable embodiment of the present disclosure, the substrate 11 (i.e., the first substrate) which contains the lattice points 13 can be but is not limited to a polyimide (PI) substrate, a polyethylene glycol terephthalate (PET) substrate or a polymethyl methacrylate (PMMA) substrate.

A thickness of the first substrate 11 is in a range from 0.5 mm to 1.5 mm, a thickness of the second substrate 12 is in a range from 0.5 mm to 1.5 mm, and a thickness of the liquid crystal layer 200 is in a range from 0.02 mm to 0.1 mm. Therefore, a thickness of the ultra-thin liquid crystal display device provided herein is in a range from 1.02 mm to 3.3 mm.

In the ultra-thin liquid crystal display device provided by the present disclosure, the polymer dispersed liquid crystals serve as the liquid crystal layer, and bright and dark display can be realized without polaroid being provided therein. One substrate in the display device is manufactured as the light guide plate to replace the traditional independent backlight module, so that the thickness of the ultra-thin liquid crystal display device is in a range from 1.02 mm to 3.3 mm. The thickness is reduced by 10 mm to 20 mm compared with the traditional liquid crystal display device. The method for manufacturing the ultra-thin liquid crystal display device provided by the present disclosure is simple. Not only thinning of the liquid crystal display device can be realized, but also the light transmittance rate thereof is high.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

### LIST OF REFERENCE SIGNS

1—backlight module;
2—lower polaroid;
3—lower substrate;
4—liquid crystal layer;
5—upper substrate;
6—upper polaroid;
100—liquid crystal cell;
11—first substrate (which contains lattice points);
12—second substrate;
13—lattice points;
14—LED light bar;
200—liquid crystal layer;
21—polymer layer; and
22—liquid crystal droplets.

1. An ultra-thin liquid crystal display device, comprising a liquid crystal cell, which comprises a first substrate, a second substrate arranged facing the first substrate, and a liquid crystal layer arranged between the first substrate and the second substrate,
wherein the liquid crystal layer has a polymer dispersed liquid crystal structure, which comprises a polymer layer and liquid crystal droplets dispersed in the polymer layer;
wherein the first substrate or the second substrate of the liquid crystal cell is to provided with lattice points on a back side thereof; and
wherein the ultra-thin liquid crystal display device further comprises an LED light bar arranged on a lateral surface of the first substrate or the second substrate which contains the lattice points.

2. The ultra-thin liquid crystal display device according to claim 1, wherein the liquid crystal droplets have an elliptical ball shape.

3. The ultra-thin liquid crystal display device according to claim 1, wherein a size of the liquid crystal droplets is in a range from 10 nm to 1000 nm.

4. The ultra-thin liquid crystal display device according to claim 1, wherein the liquid crystal layer is prepared by a mixture of a polymerizable monomer and liquid crystal molecules after polymerization reaction by treatment of UV irradiation, heating or cation curing.

5. The ultra-thin liquid crystal display device according to claim 4, wherein a content of the polymerizable monomer is 10%-60% by weight of the mixture.

6. The ultra-thin liquid crystal display device according to claim 5, wherein the polymerizable monomer comprises one or more selected from a group consisting of acrylic acid, acrylate and derivatives thereof, methacrylate and derivatives thereof, styrene and derivatives thereof, epoxy resin and a fatty amine epoxy curing agent.

7. The ultra-thin liquid crystal display device according to claim 1, wherein the first substrate or the second substrate which contains the lattice points is made of a non-glass material.

8. The ultra-thin liquid crystal display device according to claim 1, wherein a thickness of the ultra-thin liquid crystal display device is in a range from 1.02 mm to 3.3 mm.

9. A method for manufacturing an ultra-thin liquid crystal display device, comprising steps of:
S1, providing a first substrate and a second substrate which faces the first substrate, and manufacturing black matrix electrodes on the first substrate and the second substrate;
S2, arranging a mixture of a polymerizable monomer and liquid crystal molecules between the first substrate and the second substrate, wherein a content of the polymerizable monomer is 10%-60% by weight of the mixture;
S3, performing UV irradiation, heating or cation curing on the mixture, so that the polymerizable monomer experiences polymerization reaction to form a polymer layer and liquid crystal droplets dispersed in the polymer layer, wherein the polymer layer and the liquid crystal droplets dispersed in the polymer layer form a liquid crystal layer, and the liquid crystal layer, the first substrate, and the second substrate form a liquid crystal cell; and
S4, forming lattice points on a back side of the first substrate or a back side of the second substrate, and forming an LED light bar on a lateral surface of the first substrate or the second substrate which contains the lattice points to obtain the ultra-thin liquid crystal display device.

10. The method according to claim 9, wherein in step S2, the polymerizable monomer comprises one or more selected from a group consisting of acrylic acid, acrylate and derivatives thereof, methacrylate and derivatives thereof, styrene and derivatives thereof, epoxy resin and a fatty amine epoxy curing agent.

11. The method according to claim 9, wherein in step S3, the UV irradiation is performed at a temperature in a range from −30° C. to 120° C. and a baking oven, ultrasound or infrared is used in a heating procedure.

12. The method according to claim 9, wherein in step S3, the liquid crystal droplets have an elliptical ball shape.

13. The method according to claim 9, wherein in step S3, a size of the liquid crystal droplets is in a range from 10 nm to 1000 nm.

14. The method according to claim 9, wherein in step S4, the first substrate or the second substrate which contains the lattice points is made of a non-glass material.

15. The method according to claim 9, wherein in step S4, a thickness of the ultra-thin liquid crystal display device is in a range from 1.02 mm to 3.3 mm.
